(19) United States
(12) Patent Application Publication
(10) Pub. No.: US 2026/0343375 A1
(43) Pub. Date: Oct. 29, 2026

(54) METHOD FOR DETERMINING IDENTIFIER OF SIDELINK LOGICAL CHANNEL, AND APPARATUS

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 19/104,118

(22) PCT Filed: Aug. 17, 2022
(86) PCT No.: PCT/CN2022/113103

§ 371 Date: Feb. 14, 2025

(51) Int. Cl. H04W 40/02; H04L 1/1812; H04W 92/18

(52) U.S. Cl. CPC H04W 40/02; H04L 1/1812; H04W 92/18

(57) ABSTRACT

An embodiment of the present disclosure provides a method for determining an identifier of a sidelink logical channel, performed by a first terminal device. The method includes: determining an identifier of a logical channel associated with a primary path and an identifier of a logical channel associated with a secondary path corresponding to a sidelink radio bearer (SLRB), wherein the logical channel associated with the primary path and the logical channel associated with the secondary path corresponding to the SLRB are mapped to different carriers or different carrier groups; and sending the identifier of the logical channel associated with the primary path and the identifier of the logical channel associated with the secondary path corresponding to the SLRB to a second terminal device.

### CROSS REFERENCE TO RELATED APPLICATIONS

The present application is a U.S. national phase of International Application No. PCT/CN2022/113103, filed on Aug. 17, 2022, the disclosure of which is incorporated herein by reference in its entirety.

### TECHNICAL FIELD

The present disclosure relates to the field of communication technology, and in particular to methods and apparatuses for determining an identifier of a sidelink logical channel.

### BACKGROUND

In related technologies, in order to support direct communication between terminal devices, a sidelink communication manner is introduced. In addition, packet data convergence protocol (PDCP) duplication is to send a data packet repeatedly, so that the data packet can be transmitted repeatedly, which can improve the reliability of data packet transmission, and reduce the delay of sending repeatedly, meeting requirements of high reliability and low latency. However, in sidelink communication, how to ensure that two data packets of PDCP duplication are transmitted using different logical channels is an urgent problem to be solved.

### SUMMARY

An embodiment of a first aspect of the present disclosure provides a method for determining an identifier of a sidelink logical channel, applied to a first terminal device. The method includes: determining an identifier of a logical channel associated with a primary path and an identifier of a logical channel associated with a secondary path corresponding to a sidelink radio bearer (SLRB), where the logical channel associated with the primary path and the logical channel associated with the secondary path corresponding to the SLRB are mapped to different carriers or different carrier groups; and sending the identifier of the logical channel associated with the primary path and the identifier of the logical channel associated with the secondary path corresponding to the SLRB to a second terminal device.

An embodiment of a second aspect of the present disclosure provides another method for determining an identifier of a sidelink logical channel, applied to a network device. The method includes: determining an identifier of a logical channel associated with a primary path and an identifier of a logical channel associated with a secondary path corresponding to a sidelink radio bearer (SLRB), where the logical channel associated with the primary path and the logical channel associated with the secondary path corresponding to the SLRB are mapped to different carriers or different carrier groups; and sending configuration information to a first terminal device, where the configuration information includes the identifier of the logical channel associated with the primary path and the identifier of the logical channel associated with the secondary path corresponding to the SLRB.

An embodiment of a third aspect of the present disclosure provides another method for determining an identifier of a sidelink logical channel, applied to a second terminal device. The method includes: receiving an identifier of a logical channel associated with a primary path and an identifier of a logical channel associated with a secondary path corresponding to a sidelink radio bearer (SLRB) sent by a first terminal device, where the logical channel associated with the primary path and the logical channel associated with the secondary path corresponding to the SLRB are mapped to different carriers or different carrier groups.

An embodiment of a fourth aspect of the present disclosure provides a communication apparatus, including: a processing module, configured to determine an identifier of a logical channel associated with a primary path and an identifier of a logical channel associated with a secondary path corresponding to a sidelink radio bearer (SLRB), where the logical channel associated with the primary path and the logical channel associated with the secondary path corresponding to the SLRB are mapped to different carriers or different carrier groups; and a transceiver module, configured to send the identifier of the logical channel associated with the primary path and the identifier of the logical channel associated with the secondary path corresponding to the SLRB to a second terminal device.

An embodiment of a fifth aspect of the present disclosure provides another communication apparatus, including: a processing module, configured to determine an identifier of a logical channel associated with a primary path and an identifier of a logical channel associated with a secondary path corresponding to a sidelink radio bearer (SLRB), where the logical channel associated with the primary path and the logical channel associated with the secondary path corresponding to the SLRB are mapped to different carriers or different carrier groups; and a transceiver module, configured to send configuration information to a first terminal device, where the configuration information includes the identifier of the logical channel associated with the primary path and the identifier of the logical channel associated with the secondary path corresponding to the SLRB.

An embodiment of a sixth aspect of the present disclosure provides another communication apparatus, including: a transceiver module, configured to receive an identifier of a logical channel associated with a primary path and an identifier of a logical channel associated with a secondary path corresponding to a sidelink radio bearer (SLRB) sent by a first terminal device, where the logical channel associated with the primary path and the logical channel associated with the secondary path corresponding to the SLRB are mapped to different carriers or different carrier groups.

An embodiment of a seventh aspect of the present disclosure provides a communication apparatus including a processor which, when calls a computer program in a memory, performs the method described in the first aspect.

An embodiment of an eighth aspect of the present disclosure provides another communication apparatus including a processor which, when calls a computer program in a memory, performs the method described in the second aspect.

An embodiment of a ninth aspect of the present disclosure provides another communication apparatus including a processor which, when calls a computer program in a memory, performs the method described in the third aspect.

An embodiment of a tenth aspect of the present disclosure provides a communication apparatus, including one or more processors and a memory, where the memory stores a computer program, and the one or more processors execute the computer program stored in the memory to cause the communication apparatus to perform the method described in the first aspect.

An embodiment of a eleventh aspect of the present disclosure provides another communication apparatus, including one or more processors and a memory, where the memory stores a computer program, and the one or more processors execute the computer program stored in the memory to cause the communication apparatus to perform the method described in the second aspect.

An embodiment of a twelfth aspect of the present disclosure provides another communication apparatus, including one or more processors and a memory, where the memory stores a computer program, and the one or more processors execute the computer program stored in the memory to cause the communication apparatus to perform the method described in the third aspect.

An embodiment of a thirteenth aspect of the present disclosure provides another communication apparatus, including a processor and an interface circuit. The interface circuit is used to receive code instructions and transmit them to the processor. The processor is used to run the code instructions to cause the communication apparatus to perform the method described in the first aspect.

An embodiment of a fourteenth aspect of the present disclosure provides another communication apparatus, including a processor and an interface circuit. The interface circuit is used to receive code instructions and transmit them to the processor. The processor is used to run the code instructions to cause the communication apparatus to perform the method described in the second aspect.

An embodiment of a fifteenth aspect of the present disclosure provides another communication apparatus, including a processor and an interface circuit. The interface circuit is used to receive code instructions and transmit them to the processor. The processor is used to run the code instructions to cause the communication apparatus to perform the method described in the third aspect.

An embodiment of a sixteenth aspect of the present disclosure provides a system for determining an identifier of a sidelink logical channel, which includes the communication apparatus as described in the fourth aspect, the communication apparatus as described in the fifth aspect, and the configuration information transmission apparatus as described in the sixth aspect. Or, the system includes the communication apparatus as described in the seventh aspect, the communication apparatus as described in the eighth aspect, and the communication apparatus as described in the ninth aspect. Or, the system includes the communication apparatus as described in the tenth aspect, the communication apparatus as described in the eleventh aspect, and the communication apparatus as described in the twelfth aspect. Or, the system includes the communication apparatus as described in the thirteenth aspect, the communication apparatus as described in the fourteenth aspect, and the communication apparatus as described in the fifteenth aspect.

An embodiment of a seventeenth aspect of the present disclosure provides a computer readable storage medium for storing instructions used for the communication apparatus described above, and when executed, the instructions cause the communication apparatus to perform the method described in the first aspect.

An embodiment of an eighteenth aspect of the present disclosure provides another computer readable storage medium for storing instructions used for the communication apparatus described above, and when executed, the instructions cause the communication apparatus to perform the method described in the second aspect.

An embodiment of a nineteenth aspect of the present disclosure provides another computer readable storage medium for storing instructions used for the communication apparatus described above, and when executed, the instructions cause the communication apparatus to perform the method described in the third aspect.

An embodiment of a twentieth embodiment of the present disclosure also provides a computer program product including a computer program, which, when runs on a computer, causes the computer to perform the method described in the first aspect.

An embodiment of a twenty-first embodiment of the present disclosure also provides a computer program product including a computer program, which, when runs on a computer, causes the computer to perform the method described in the second aspect.

An embodiment of a twenty-second embodiment of the present disclosure also provides a computer program product including a computer program, which, when runs on a computer, causes the computer to perform the method described in the third aspect.

An embodiment of a twenty-third embodiment of the present disclosure provides a chip system, including at least one processor and an interface for supporting the communication apparatus to implement the functions involved in the first aspect, for example, determining or processing at least one of the data and information involved in the above methods. In one possible design, the chip system further includes a memory for storing computer programs and data necessary for the communication apparatus. The chip system can be composed of chips or include chips and other discrete devices.

An embodiment of a twenty-fourth embodiment of the present disclosure provides another chip system, including at least one processor and an interface for supporting the communication apparatus to implement the functions involved in the second aspect, for example, determining or processing at least one of the data and information involved in the above methods. In one possible design, the chip system further includes a memory for storing computer programs and data necessary for the communication apparatus. The chip system can be composed of chips or include chips and other discrete devices.

An embodiment of a twenty-fifth embodiment of the present disclosure also provides a computer program that, when runs on a computer, causes the computer to perform the method described in the first aspect.

An embodiment of a twenty-sixth embodiment of the present disclosure also provides another computer program that, when runs on a computer, causes the computer to perform the method described in the second aspect.

An embodiment of a twenty-seventh embodiment of the present disclosure also provides another computer program that, when runs on a computer, causes the computer to perform the method described in the third aspect.

### BRIEF DESCRIPTION OF THE DRAWINGS

In order to more clearly explain the technical solution in the embodiments of the present disclosure or the background, the accompanying drawings needed in the embodiments of the present disclosure or the background will be described below.

FIG. 1 is a schematic architectural diagram of a communication system provided in an embodiment of the present disclosure;

FIG. 2 is a flowchart of a method for determining an identifier of a sidelink logical channel provided in an embodiment of the present disclosure;

FIG. 3 is a flowchart of another method for determining an identifier of a sidelink logical channel provided in an embodiment of the present disclosure;

FIG. 4 is a flowchart of another method for determining an identifier of a sidelink logical channel provided in an embodiment of the present disclosure;

FIG. 5 is a flowchart of another method for determining an identifier of a sidelink logical channel provided in an embodiment of the present disclosure;

FIG. 6 is a flowchart of another method for determining an identifier of a sidelink logical channel provided in an embodiment of the present disclosure;

FIG. 7 is a flowchart of another method for determining an identifier of a sidelink logical channel provided in an embodiment of the present disclosure;

FIG. 8 is a flowchart of another method for determining an identifier of a sidelink logical channel provided in an embodiment of the present disclosure;

FIG. 9 is a flowchart of another method for determining an identifier of a sidelink logical channel provided in an embodiment of the present disclosure;

FIG. 10 is a flowchart of another method for determining an identifier of a sidelink logical channel provided in an embodiment of the present disclosure;

FIG. 11 is a flowchart of another method for determining an identifier of a sidelink logical channel provided in an embodiment of the present disclosure;

FIG. 12 is a flowchart of another method for determining an identifier of a sidelink logical channel provided in an embodiment of the present disclosure;

FIG. 13 is a schematic structural diagram of a communication apparatus provided in an embodiment of the present disclosure;

FIG. 14 is a schematic structural diagram of another communication apparatus provided in an embodiment of the present disclosure;

FIG. 15 is a schematic structural diagram of a chip provided in an embodiment of the present disclosure.

### DETAILED DESCRIPTION OF THE EMBODIMENTS

In order to better understand methods for determining an identifier of a sidelink logical channel according to the embodiments of the present disclosure, a communication system to which the embodiments of the present disclosure are applicable is firstly described below.

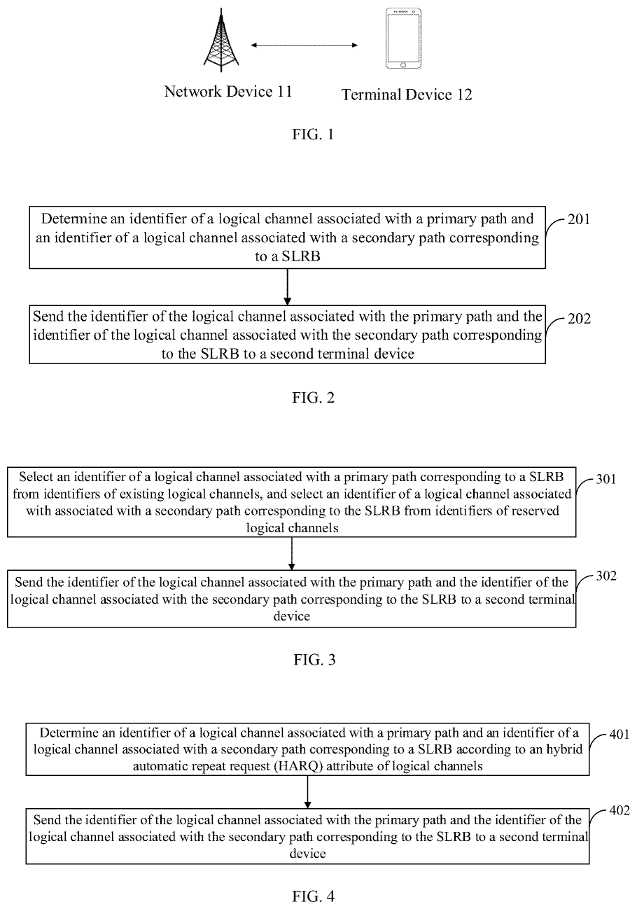

Referring to FIG. 1, FIG. 1 is a schematic architectural diagram of a communication system provided in an embodiment of the present disclosure. The communication system may include, but is not limited to, one network device and one terminal device. The number and form of devices illustrated in FIG. 1 are examples only and do not constitute a limitation on the embodiments of the present disclosure. In practical applications, two or more network devices, and/or two or more terminal devices may be included. The communication system illustrated in FIG. 1 includes one network device 11 and one terminal device 12 as an example.

It should be noted that the technical solution according to the embodiments of the present disclosure may be applied to various communication systems, for example, a long term evolution (LTE) system, a fifth generation (5G) mobile communication system, a 5G new radio (NR) system, or other future mobile communication systems, etc.

The network device 11 in the embodiments of the present disclosure is an entity on a network side for transmitting or receiving signals. For example, the network device 11 may be an evolved NodeB (eNB), a transmission reception point (TRP), a next generation NodeB (gNB) in an NR system, a base station in other future mobile communication systems, or an access node in a wireless fidelity (WiFi) system, etc. The embodiments of the present disclosure do not limit the specific technology and specific device form adopted by the network device. The network device according to the embodiments of the present disclosure may be composed of a central unit (CU) and distributed unit(s) (DU(s)). The CU may also be referred to as a control unit. By adapting the CU-DU architecture, the network device, such as protocol layers of the base station, may be separated, placing functions of some protocol layers in the CU for centralized control, and distributing functions of the remaining part or all of protocol layers in the DU(s) for centrally control by the CU.

The terminal device 102 in the embodiments of the present disclosure is an entity on a user side for receiving or transmitting signals, for example, a mobile phone. The terminal device may also be referred to as a terminal, user equipment (UE), a mobile station (MS), a mobile terminal (MT) and so on. The terminal device may be a vehicle having a communication function, a smart vehicle, a mobile phone, a wearable device, a Pad, a computer having a wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, or the like. The embodiments of the present disclosure do not limit the specific technology and specific device form adopted by the terminal device.

It can be understood that the communication system described in the embodiments of the present disclosure is to illustrate the technical solution according to the embodiments of the present disclosure more clearly, and does not constitute a limitation on the technical solution provided in the embodiments of the present disclosure. Those skilled in the art know that with the evolution of system architecture and the emergence of new business scenarios, the technical solution provided in the embodiments of the present disclosure is also applicable to similar technical problems.

In related technologies, in order to support direct communication between terminal devices, a sidelink communication manner is introduced. In addition, packet data convergence protocol (PDCP) duplication is to send a data packet repeatedly, so that the data packet can be transmitted repeatedly, which can improve the reliability of data packet transmission, and reduce the delay of sending repeatedly, meeting requirements of high reliability and low latency. However, in sidelink communication, how to ensure that two data packets of PDCP duplication are transmitted using different logical channels is an urgent problem to be solved.

In the present disclosure, a first terminal device can determine an identifier of a logical channel associated with a primary path and an identifier of a logical channel associated with a secondary path corresponding to a sidelink radio bearer (SLRB), where the logical channel associated with the primary path and the logical channel associated with the secondary path are mapped to different carriers or different carrier groups, and send the identifier of the logical channel associated with the primary path and the identifier of the logical channel associated with the secondary path corresponding to the SLRB to a second terminal device, thereby ensuring that two data packets of PDCP duplication are transmitted using different logical channels.

The methods and apparatuses for determining an identifier of a sidelink logical channel provided by the present disclosure will be described in detail in combination with the accompanying drawings.

Referring to FIG. 2, FIG. 2 is a flowchart of a method for determining an identifier of a sidelink logical channel provided in an embodiment of the present disclosure, which is performed by a first terminal device. As shown in FIG. 2, the method may include but is not limited to steps 201 and 202.

In step 201, an identifier of a logical channel associated with a primary path and an identifier of a logical channel associated with a secondary path corresponding to a SLRB are determined.

The identifier of the logical channel associated with the primary path may refer to an identifier of a logical channel for transmitting an original PDCP data packet. The identifier of the logical channel associated with the secondary path may refer to an identifier of a logical channel for transmitting a replicated PDCP data packet.

The logical channel associated with the primary path and the logical channel associated with the secondary path are mapped to different carriers or different carrier groups.

In the present disclosure, the logical channel associated with the primary path and the logical channel associated with the secondary path corresponding to each SLRB can be determined. Since an identifier can represent the uniqueness of a logical channel, the identifier of the logical channel associated with the primary path and the identifier of the logical channel associated with the secondary path corresponding to each SLRB can be determined.

In the present disclosure, the identifier of the logical channel associated with the primary path and the identifier of the logical channel associated with the secondary path corresponding to the SLRB can be directly determined by the first terminal device, or determined by the first terminal device based on configuration information sent by a network device, which carries the identifier of the logical channel associated with the primary path and the identifier of the logical channel associated with the secondary path corresponding to the SLRB.

Optionally, the identifier of the logical channel associated with the primary path and the identifier of the logical channel associated with the secondary path corresponding to the SLRB may also be pre-configured.

In step 202, the identifier of the logical channel associated with the primary path and the identifier of the logical channel associated with the secondary path corresponding to the SLRB are sent to a second terminal device.

The second terminal device may be a terminal device that establishes a uncast connection with the first terminal device, or the second terminal device may also be a terminal device in a group to which the first terminal device belongs, or the second terminal device may also be a terminal device that receives broadcast services, which is not limited in the present disclosure.

In the present disclosure, the first terminal device may send the identifier of the logical channel associated with the primary path and the identifier of the logical channel associated with the secondary path corresponding to the SLRB to the second terminal device for notification to the second terminal device.

In the embodiment of the present disclosure, the first terminal device can determine the identifier of the logical channel associated with the primary path and the identifier of the logical channel associated with the secondary path corresponding to the SLRB, where the logical channel associated with the primary path and the logical channel associated with the secondary path corresponding to the SLRB are mapped to different carriers or different carrier groups, and send the identifier of the logical channel associated with the primary path and the identifier of the logical channel associated with the secondary path corresponding to the SLRB to the second terminal device. Therefore, when PDCP duplication of the SLRB is activated, it can ensure that two data packets of PDCP duplication are transmitted using different logical channels.

Referring to FIG. 3, FIG. 3 is a flowchart of another method for determining an identifier of a sidelink logical channel provided in an embodiment of the present disclosure, which is performed by a first terminal device. As shown in FIG. 3, the method may include but is not limited to steps 301 and 302.

In step 301, an identifier of a logical channel associated with a primary path corresponding to a SLRB is selected from identifiers of existing logical channels, and an identifier of a logical channel associated with associated with a secondary path corresponding to the SLRB is selected from identifiers of reserved logical channels.

In the present disclosure, the first terminal device can select the logical channel associated with the primary path corresponding to the SLRB from the existing logical channels, and select the logical channel associated with the secondary path corresponding to the SLRB from the reserved logical channels. Since an identifier can represent the uniqueness of a logical channel, the first terminal device can select the identifier of the logical channel associated with the primary path corresponding to the SLRB from the identifiers of the existing logical channels, and select the identifier of the logical channel associated with the secondary path corresponding to the SLRB from the identifiers of the reserved logical channels.

The logical channel associated with the primary path and the logical channel associated with the secondary path corresponding to the SLRB are mapped to different carriers or different carrier groups. Identifiers of logical channels associated with primary paths corresponding to different SLRBs are different, and identifiers of logical channels associated with secondary paths corresponding to different SLRBs are different.

For example, if the identifiers of the existing logical channels are 1 to 10, and the identifiers of the reserved logical channels are 11 to 20, a logical channel with an identifier 1 can be used as a logical channel associated with a primary path corresponding to a certain SLRB, a logical channel with an identifier 11 can be used as a logical channel associated with a secondary path of the certain SLRB, a logical channel with an identifier 2 can be used as a logical channel associated with a primary path of another SLRB, and a logical channel with an identifier 12 can be used as a logical channel associated with a secondary path of the another SLRB.

It should be noted that the above identifiers of the existing logical channels and identifiers of the reserved logical channels are only examples and should not be regarded as limitations on the present disclosure.

In step 302, the identifier of the logical channel associated with the primary path and the identifier of the logical channel associated with the secondary path corresponding to the SLRB are sent to a second terminal device.

In the present disclosure, the second terminal device may be a terminal device that establishes a PC5-radio resource control (PC5-RRC) uncast connection based on a PC5 interface with the first terminal device. In this case, the first terminal device can send the identifier of the logical channel associated with the primary path and the identifier of the logical channel associated with the secondary path corresponding to the SLRB to the second terminal device based on PC5-RRC signaling, or can also send the identifier of the logical channel associated with the primary path and the identifier of the logical channel associated with the secondary path corresponding to the SLRB to the second terminal device through a sidelink media access control control element (SL MAC CE).

The PC5-RRC signaling can be RRCReconfigurationSidelink signaling.

Optionally, the SL MAC CE can carry identifiers of logical channels associated with primary paths and identifiers of logical channels associated with secondary paths corresponding to one or more SLRBs.

Therefore, for unicast services, the first terminal device can notify the second terminal device that establishes a PC5-RRC uncast connection with the first terminal device of the identifier of the logical channel associated with the primary path and the identifier of the logical channel associated with the secondary path corresponding to the SLRB through the PC5-RRC signaling or SL MAC CE.

Optionally, the second terminal device may also be a terminal device in a group to which the first terminal device belongs, or the second terminal device may be a terminal device that receives broadcast services. In this case, the first terminal device can send the identifier of the logical channel associated with the primary path and the identifier of the logical channel associated with the secondary path corresponding to the SLRB to the second terminal device through the SL MAC CE.

Optionally, the SL MAC CE can carry identifiers of logical channels associated with primary paths and identifiers of logical channels associated with secondary paths corresponding to one or more SLRBs.

Therefore, for multicast or broadcast services, the first terminal device can carry the identifier of the logical channel associated with the primary path and the identifier of the logical channel associated with the secondary path corresponding to the SLRB through the SL MAC CE to notify other terminal devices in the group or terminal devices receiving broadcast services.

Referring to FIG. 4, FIG. 4 is a flowchart of another method for determining an identifier of a sidelink logical channel provided in an embodiment of the present disclosure, which is performed by a first terminal device. As shown in FIG. 4, the method may include but is not limited to steps 401 and 402.

In step 401, an identifier of a logical channel associated with a primary path and an identifier of a logical channel associated with a secondary path corresponding to a SLRB are determined according to an hybrid automatic repeat request (HARQ) attribute of logical channels.

The HARQ attribute can include HARQ enabled and HARQ disabled.

In the present disclosure, the logical channel associated with the primary path and the logical channel associated with the secondary path corresponding to the SLRB are mapped to different carriers or different carrier groups. Identifiers of logical channels associated with primary paths corresponding to different SLRBs are different, and identifiers of logical channels associated with secondary paths corresponding to different SLRBs are different. In the present disclosure, the first terminal device can determine the identifier of the logical channel associated with the primary path and the identifier of the logical channel associated with the secondary path corresponding to the SLRB according to the HARQ attribute of the logical channels, so as to ensure that the HARQ attribute of the logical channel associated with the primary path is the same as the HARQ attribute of the logical channel associated with the secondary path.

The HARQ attribute of the logical channel associated with the primary path is the same as the HARQ attribute of the logical channel associated with the secondary path, which can be that the HARQ attribute of the logical channel associated with the primary path and the HARQ attribute of the logical channel associated with the secondary path are both HARQ enabled, or can be that the HARQ attribute of the logical channel associated with the primary path and the HARQ attribute of the logical channel associated with the secondary path are both HARQ disabled.

Optionally, the HARQ attribute of the logical channel associated with the primary path is the same as the HARQ attribute of the logical channel associated with the secondary path, which also can be that the HARQ attribute of the logical channel associated with the primary path is default, while the HARQ attribute of the logical channel associated with the secondary path is HARQ enabled or HARQ disabled, or the HARQ attribute of the logical channel associated with the secondary path is default.

In step 402, the identifier of the logical channel associated with the primary path and the identifier of the logical channel associated with the secondary path corresponding to the SLRB are sent to a second terminal device.

In the present disclosure, step 402 can be implemented in any of the embodiments of the present disclosure, which is not limited in the embodiments of the present disclosure and will not be repeated herein.

In the embodiment of the present disclosure, the first terminal device can determine the identifier of the logical channel associated with the primary path and the identifier of the logical channel associated with the secondary path corresponding to the SLRB according to the HARQ attribute of the logical channels, and send the identifier of the logical channel associated with the primary path and the identifier of the logical channel associated with the secondary path corresponding to the SLRB to the second terminal device. Thus, it can be ensured that the logical channel associated with the primary path and the logical channel associated with the secondary path have the same HARQ attribute.

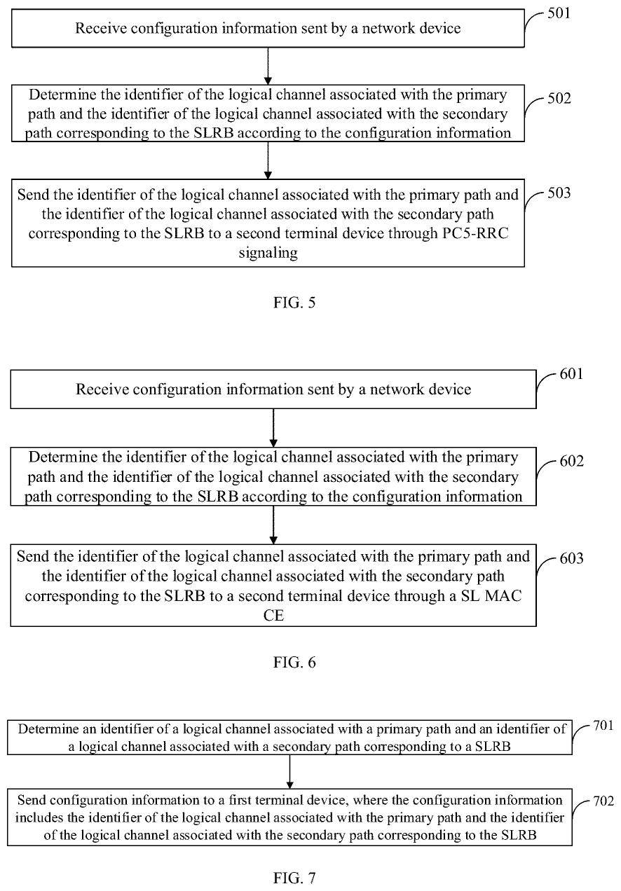

Referring to FIG. 5, FIG. 5 is a flowchart of another method for determining an identifier of a sidelink logical channel provided in an embodiment of the present disclosure, which is performed by a first terminal device. As shown in FIG. 5, the method may include but is not limited to steps 501 to 503.

In step 501, configuration information sent by a network device is received.

In the present disclosure, the network device can determine an identifier of a logical channel associated with a primary path and an identifier of a logical channel associated with a secondary path corresponding to a SLRB, and send configuration information to the first terminal device. The configuration information may include the identifier of the logical channel associated with the primary path and the identifier of the logical channel associated with the secondary path corresponding to the SLRB.

In the present disclosure, the configuration information may be radio bearer configuration information. That is, the radio bearer configuration information carries the identifier of the logical channel associated with the primary path and the identifier of the logical channel associated with the secondary path corresponding to the SLRB.

In the present disclosure, the logical channel associated with the primary path and the logical channel associated with the secondary path corresponding to the SLRB are mapped to different carriers or different carrier groups.

In step 502, the identifier of the logical channel associated with the primary path and the identifier of the logical channel associated with the secondary path corresponding to the SLRB are determined according to the configuration information.

In the present disclosure, the first terminal device can determine the identifier of the logical channel associated with the primary path and the identifier of the logical channel associated with the secondary path corresponding to the SLRB according to the configuration information.

In step 503, the identifier of the logical channel associated with the primary path and the identifier of the logical channel associated with the secondary path corresponding to the SLRB are sent to a second terminal device through PC5-RRC signaling.

The second terminal device may be a terminal device that establishes a PC5-RRC uncast connection with the first terminal device.

In the present disclosure, the first terminal device can send the identifier of the logical channel associated with the primary path and the identifier of the logical channel associated with the secondary path corresponding to the SLRB to the second terminal device through the PC5-RRC signaling, to notify the second terminal device of the identifier of the logical channel associated with the primary path and the identifier of the logical channel associated with the secondary path corresponding to the SLRB.

Optionally, the first terminal device can also send the identifier of the logical channel associated with the primary path and the identifier of the logical channel associated with the secondary path corresponding to the SLRB to the second terminal device through a SL MAC CE.

Optionally, the SL MAC CE can carry identifiers of logical channels associated with primary paths and identifiers of logical channels associated with secondary paths corresponding to one or more SLRBs.

In the embodiment of the present disclosure, the first terminal device can receive the configuration information sent by the network device, determine the identifier of the logical channel associated with the primary path and the identifier of the logical channel associated with the secondary path corresponding to the SLRB according to the configuration information, and through the PC5-RRC signaling or SL MAC CE, send the identifier of the logical channel associated with the primary path and the identifier of the logical channel associated with the secondary path corresponding to the SLRB to the second terminal device that establishes a uncast connection with the first terminal device. Therefore, for unicast services, it can ensure that two data packets of PDCP duplication are transmitted using different logical channels.

Referring to FIG. 6, FIG. 6 is a flowchart of another method for determining an identifier of a sidelink logical channel provided in an embodiment of the present disclosure, which is performed by a first terminal device. As shown in FIG. 6, the method may include but is not limited to steps 601 to 603.

In step 601, configuration information sent by a network device is received.

In step 602, an identifier of a logical channel associated with a primary path and an identifier of a logical channel associated with a secondary path corresponding to a SLRB are determined according to the configuration information.

In the present disclosure, steps 601 to 602 can be implemented in any of the embodiments of the present disclosure, which is not limited in the embodiments of the present disclosure and will not be repeated herein.

In step 603, the identifier of the logical channel associated with the primary path and the identifier of the logical channel associated with the secondary path corresponding to the SLRB are sent to a second terminal device through a SL MAC CE.

The second terminal device may be a terminal device in a group to which the first terminal device belongs, or the second terminal device may also be a terminal device that receives broadcast services.

In the present disclosure, for multicast or broadcast services, the first terminal device can send the identifier of the logical channel associated with the primary path and the identifier of the logical channel associated with the secondary path corresponding to the SLRB to other terminal devices in the group or terminal devices receiving broadcast services through the SL MAC CE, to notify other terminal devices in the group or the terminal devices receiving broadcast services of the identifier of the logical channel associated with the primary path and the identifier of the logical channel associated with the secondary path corresponding to the SLRB.

In the embodiment of the present disclosure, for multicast or broadcast services, the first terminal device can receive the configuration information sent by the network device, determine the identifier of the logical channel associated with the primary path and the identifier of the logical channel associated with the secondary path corresponding to the SLRB according to the configuration information, and send them to the terminal devices in the group or the terminal devices receiving broadcast services through the SL MAC CE. Therefore, for multicast or broadcast services, it can ensure that two data packets of PDCP duplication are transmitted using different logical channels.

Referring to FIG. 7, FIG. 7 is a flowchart of another method for determining an identifier of a sidelink logical channel provided in an embodiment of the present disclosure, which is performed by a network device. As shown in FIG. 7, the method may include but is not limited to steps 701 and 702.

In step 701, an identifier of a logical channel associated with a primary path and an identifier of a logical channel associated with a secondary path corresponding to a SLRB are determined.

The logical channel associated with the primary path and the logical channel associated with the secondary path are mapped to different carriers or different carrier groups.

In the present disclosure, the network device can select the identifier of the logical channel associated with the primary path from identifiers of existing logical channels, and select the identifier of the logical channel associated with the secondary path from identifiers of reserved logical channels.

Optionally, the network device can also determine the identifier of the logical channel associated with the primary path and the identifier of the logical channel associated with the secondary path corresponding to the SLRB according to a HARQ attribute of logical channels. The HARQ attribute of logical channels can include HARQ enabled and HARQ disabled.

In step 702, configuration information is sent to a first terminal device, where the configuration information includes the identifier of the logical channel associated with the primary path and the identifier of the logical channel associated with the secondary path corresponding to the SLRB.

The configuration information can be radio bearer configuration information. That is, the radio bearer configuration information carries the identifier of the logical channel associated with the primary path and the identifier of the logical channel associated with the secondary path corresponding to the SLRB.

In the present disclosure, the network device can send the radio bearer configuration information to the first terminal device, carrying the identifier of the logical channel associated with the primary path and the identifier of the logical channel associated with the secondary path corresponding to the SLRB, and notify the first terminal device of the identifier of the logical channel associated with the primary path and the identifier of the logical channel associated with the secondary path corresponding to the SLRB through the radio bearer configuration information.

In the embodiment of the present disclosure, the network device can determine the identifier of the logical channel associated with the primary path and the identifier of the logical channel associated with the secondary path corresponding to the SLRB, and send the configuration information to the first terminal device, where the configuration information includes the identifier of the logical channel associated with the primary path and the identifier of the logical channel associated with the secondary path corresponding to the SLRB. Thus, the first terminal device can determine the identifier of the logical channel associated with the primary path and the identifier of the logical channel associated with the secondary path corresponding to the SLRB according to the configuration information, thereby ensuring that two data packets of PDCP duplication are transmitted using different logical channels.

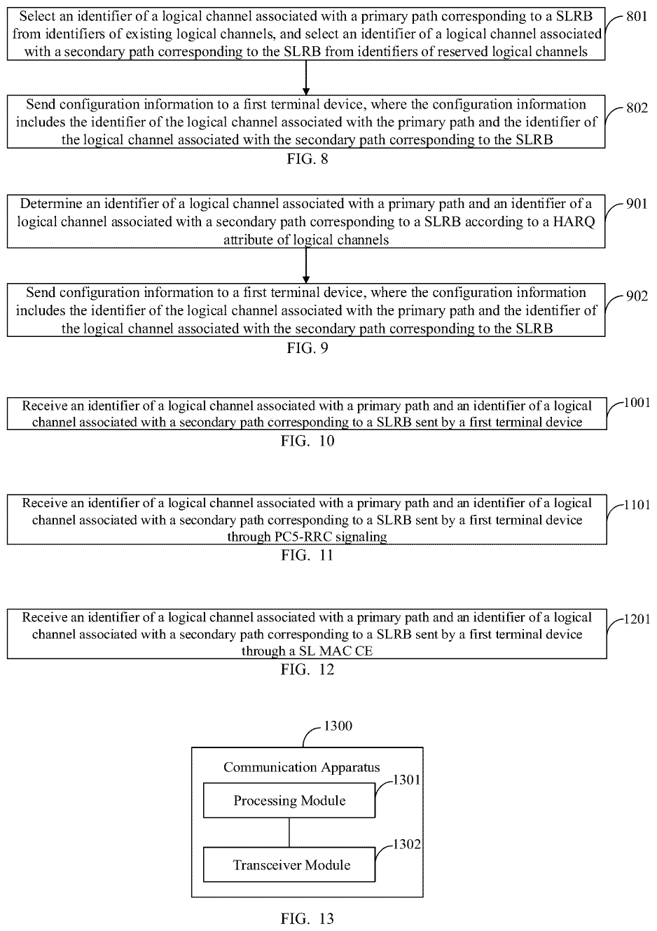

Please refer to FIG. 8, FIG. 8 is a flowchart of another method for determining an identifier of a sidelink logical channel provided in an embodiment of the present disclosure, which is performed by a network device. As shown in FIG. 8, the method may include but is not limited to steps 801 and 802.

In step 801, an identifier of a logical channel associated with a primary path corresponding to a SLRB is selected from identifiers of existing logical channels, and an identifier of a logical channel associated with a secondary path corresponding to the SLRB is selected from identifiers of reserved logical channels.

Identifiers of logical channels associated with primary paths corresponding to different SLRBs are different, and identifiers of logical channels associated with secondary paths corresponding to different SLRBs are different.

In the present disclosure, reference can be made to the method of determining the identifier of the logical channel associated with the primary path and the identifier of the logical channel associated with the secondary path according to the identifiers of existing logical channels and the identifiers of reserved logical channels by the first terminal device mentioned above, which will not be repeated here.

In step 802, configuration information is sent to a first terminal device, where the configuration information includes the identifier of the logical channel associated with the primary path and the identifier of the logical channel associated with the secondary path corresponding to the SLRB.

In the present disclosure, step 802 can be implemented in any of the embodiments of the present disclosure, and the embodiments of the present disclosure do not limit this and will not be repeated here.

In the embodiment of the present disclosure, the network device can select the identifier of the logical channel associated with the primary path corresponding to the SLRB from the identifiers of existing logical channels, and select the identifier of the logical channel associated with the secondary path corresponding to the SLRB from the identifiers of reserved logical channels, and send the configuration information to the first terminal device, where the configuration information includes the identifier of the logical channel associated with the primary path and the identifier of the logical channel associated with the secondary path corresponding to the SLRB. Thus, it can be ensured that two data packets of PDCP duplication are transmitted using different logical channels.

Referring to FIG. 9, FIG. 9 is a flowchart of another method for determining an identifier of a sidelink logical channel provided in an embodiment of the present disclosure, which is performed by a network device. As shown in FIG. 9, the method may include but is not limited to steps 901 and 902.

In step 901, an identifier of a logical channel associated with a primary path and an identifier of a logical channel associated with a secondary path corresponding to a SLRB are determined according to a HARQ attribute of logical channels.

In the present disclosure, reference can be made to the method of determining the identifier of the logical channel associated with the primary path and the identifier of the logical channel associated with the secondary path corresponding to the SLRB according to the HARQ attribute of logical channels by the first terminal device mentioned above, which will not be repeated here.

In step 902, configuration information is sent to a first terminal device, where the configuration information includes the identifier of the logical channel associated with the primary path and the identifier of the logical channel associated with the secondary path corresponding to the SLRB.

In the present disclosure, step 902 can be implemented in any of the embodiments of the present disclosure, and the embodiments of the present disclosure do not limit this and will not be repeated here.

In the embodiment of the present disclosure, the network device may determine the identifier of the logical channel associated with the primary path and the identifier of the logical channel associated with the secondary path corresponding to the SLRB according to the HARQ attribute of logical channels, and send the configuration information to the first terminal device, where the configuration information includes the identifier of the logical channel associated with the primary path and the identifier of the logical channel associated with the secondary path corresponding to the SLRB. Thus, it can be ensured that the logical channel associated with the primary path and the logical channel associated with the secondary path have the same HARQ attribute.

Optionally, for multicast or broadcast services, an identifier of a logical channel associated with a primary path and an identifier of a logical channel associated with a secondary path corresponding to a SLRB can be specified in a protocol. When PDCP duplication of a certain SLRB of a terminal device is activated, two data packets of PDCP duplication can be transmitted according to the identifier of the logical channel associated with the primary path and the identifier of the logical channel associated with the secondary path corresponding to the SLRB specified in the protocol.

The identifier of the logical channel associated with the primary path corresponding to the SLRB in the protocol can be selected from identifiers of reserved logical channels associated with primary paths specifically for multicast or broadcast services in identifiers of existing logical channels, and the identifier of the logical channel associated with the secondary path corresponding to the SLRB can be selected from identifiers of specifically reserved same number of logical channels associated with secondary paths for multicast or broadcast services in identifiers of reserved logical channels.

Referring to FIG. 10, FIG. 10 is a flowchart of another method for determining an identifier of a sidelink logical channel provided in an embodiment of the present disclosure, which is performed by a second terminal device. As shown in FIG. 10, the method may include but is not limited to step 1001.

In step 1001: an identifier of a logical channel associated with a primary path and an identifier of a logical channel associated with a secondary path corresponding to a SLRB sent by a first terminal device are received.

The logical channel associated with the primary path and the logical channel associated with the secondary path are mapped to different carriers or different carrier groups.

In the present disclosure, the second terminal device may be a terminal device that establishes a uncast connection with the first terminal device, or the second terminal device may also be a terminal device in a group to which the first terminal device belongs, or the second terminal device may also be a terminal device that receives broadcast services, which is not limited in the present disclosure.

In the present disclosure, the identifier of the logical channel associated with the primary path and the identifier of the logical channel associated with the secondary path corresponding to the SLRB can be directly determined by the first terminal device, or determined by the first terminal device based on configuration information sent by a network device, which carries the identifier of the logical channel associated with the primary path and the identifier of the logical channel associated with the secondary path corresponding to the SLRB.

Optionally, the identifier of the logical channel associated with the primary path and the identifier of the logical channel associated with the secondary path corresponding to the SLRB may also be pre-configured.

In the embodiment of the present disclosure, the second terminal device can receive the identifier of the logical channel associated with the primary path and the identifier of the logical channel associated with the secondary path corresponding to the SLRB sent by the first terminal device, so that the second terminal device can obtain the identifier of the logical channel associated with the primary path and the identifier of the logical channel associated with the secondary path corresponding to the SLRB notified by the first terminal device. Thus, when PDCP duplication of the SLRB is activated, it can ensure that two data packets of PDCP duplication are transmitted on different logical channels.

Please refer to FIG. 11, FIG. 11 is a flowchart of another method for determining an identifier of a sidelink logical channel provided in an embodiment of the present disclosure, which is performed by a second terminal device. As shown in FIG. 11, the method may include but is not limited to step 1101.

In step 1101, an identifier of a logical channel associated with a primary path and an identifier of a logical channel associated with a secondary path corresponding to a SLRB sent by a first terminal device through PC5-RRC signaling are received.

The second terminal device can be a terminal device that establishes a PC5-RRC uncast connection with the first terminal device.

Optionally, the PC5-RRC signaling can be RRCReconfigurationSidelink signaling.

Optionally, the first terminal device can also send the identifier of the logical channel associated with the primary path and the identifier of the logical channel associated with the secondary path corresponding to the SLRB to the second terminal device through a SL MAC CE.

Optionally, the SL MAC CE can carry identifiers of logical channels associated with primary paths and identifiers of logical channels associated with secondary paths corresponding to one or more SLRBs.

In the present disclosure, for the explanation of the identifier of the logical channel associated with the primary path and the identifier of the logical channel associated with the secondary path corresponding to the SLRB, please refer to the above embodiments, and will not be repeated here.

In the embodiment of the present disclosure, the second terminal device that establishes the PC5-RRC uncast connection with the first terminal device can receive the identifier of the logical channel associated with the primary path and the identifier of the logical channel associated with the secondary path corresponding to the SLRB sent by the first terminal device through the PC5-RRC signaling or SL MAC CE. Therefore, for unicast services, it can ensure that two data packets of PDCP duplication are transmitted using different logical channels.

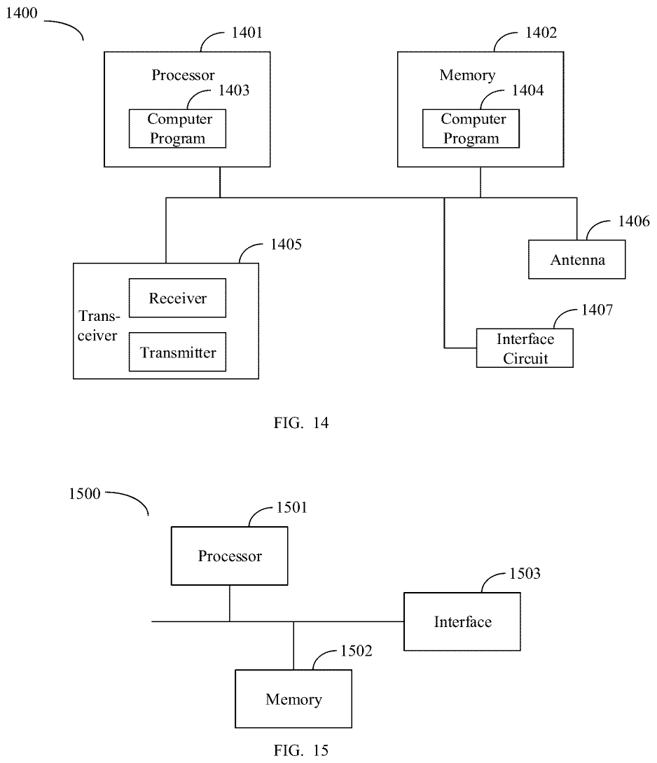

Please refer to FIG. 12, FIG. 12 is a flowchart of another method for determining an identifier of a sidelink logical channel provided in an embodiment of the present disclosure, which is performed by a second terminal device. As shown in FIG. 12, the method may include but is not limited to step 1201.

In step 1201, an identifier of a logical channel associated with a primary path and an identifier of a logical channel associated with a secondary path corresponding to a SLRB sent by a first terminal device through a SL MAC CE are received.

In the present disclosure, the second terminal device may be a terminal device in a group to which the first terminal device belongs, or the second terminal device may be a terminal device that receives broadcast services.

Optionally, the SL MAC CE can carry identifiers of logical channels associated with primary paths and identifiers of logical channels associated with secondary paths corresponding to one or more SLRBs.

In the present disclosure, for the explanation of the identifier of the logical channel associated with the primary path and the identifier of the logical channel associated with the secondary path corresponding to the SLRB, please refer to the above embodiments, and will not be repeated here.

In the embodiment of the present disclosure, the second terminal device in the group to which the first terminal device belongs or the second terminal device that receives broadcast services can receive the identifier of the logical channel associated with the primary path and the identifier of the logical channel associated with the secondary path corresponding to the SLRB sent by the first terminal device through the SL MAC CE. Therefore, for multicast or broadcast services, it can ensure that two data packets of PDCP duplication are transmitted using different logical channels.

Referring to FIG. 13, FIG. 13 is a schematic structural diagram of a communication apparatus provided in an embodiment of the present disclosure. The communication apparatus 1300 shown in FIG. 13 can include a processing module 1301 and a transceiver module 1302. The transceiver module 1302 can include a sending module and/or a receiving module. The sending module is configured to implement a sending function, and the receiving module is configured to implement a receiving function. The transceiver module 1302 can implement the sending function and/or the receiving function.

It can be understood that the communication apparatus 1300 can be a first terminal device, an apparatus in a first terminal device, or an apparatus that can be used in conjunction with the first terminal device.

The communication apparatus 1300 is on the first terminal device side, where: the processing module 1301 is configured to determine an identifier of a logical channel associated with a primary path and an identifier of a logical channel associated with a secondary path corresponding to a sidelink radio bearer (SLRB), where the logical channel associated with the primary path and the logical channel associated with the secondary path corresponding to the SLRB are mapped to different carriers or different carrier groups; the transceiver module 1302 is configured to send the identifier of the logical channel associated with the primary path and the identifier of the logical channel associated with the secondary path corresponding to the SLRB to a second terminal device.

Optionally, the processing module 1301 is configured to: select the identifier of the logical channel associated with the primary path corresponding to the SLRB from identifiers of existing logical channels, and select the identifier of the logical channel associated with the secondary path corresponding to the SLRB from identifiers of reserved logical channels, where identifiers of logical channels associated with primary paths corresponding to different SLRBs are different, and identifiers of logical channels associated with secondary paths corresponding to different SLRBs are different.

Optionally, the processing module 1301 is configured to: determine the identifier of the logical channel associated with the primary path and the identifier of the logical channel associated with the secondary path corresponding to the SLRB according to an hybrid automatic repeat request (HARQ) attribute of logical channels.

Optionally, the HARQ attribute of the logical channel associated with the primary path and the HARQ attribute of the logical channel associated with the secondary path are both HARQ enabled, or the HARQ attribute of the logical channel associated with the primary path and the HARQ attribute of the logical channel associated with the secondary path are both HARQ disabled.

Optionally, the HARQ attribute of the logical channel associated with the primary path is default; and the HARQ attribute of the logical channel associated with the secondary path is HARQ enabled or HARQ disabled, or the HARQ attribute of the logical channel associated with the secondary path is default.

Optionally, the transceiver module 1302 is configured to receive configuration information sent by a network device; and the processing module 1301 is configured to determine the identifier of the logical channel associated with the primary path and the identifier of the logical channel associated with the secondary path corresponding to the SLRB according to the configuration information.

Optionally, the configuration information is radio bearer configuration information.

Optionally, the transceiver module 1302 is configured to: send the identifier of the logical channel associated with the primary path and the identifier of the logical channel associated with the secondary path corresponding to the SLRB to the second terminal device through PC5-radio resource control (PC5-RRC) signaling, where the second terminal device is a terminal device that establishes a PC5-RRC uncast connection with the first terminal device.

Optionally, the transceiver module 1302 is configured to: send the identifier of the logical channel associated with the primary path and the identifier of the logical channel associated with the secondary path corresponding to the SLRB to the second terminal device through a sidelink media access control control element (SL MAC CE), where the second terminal device is a terminal device that establishes a PC5-RRC uncast connection with the first terminal device.

Optionally, the transceiver module 1302 is configured to: send the identifier of the logical channel associated with the primary path and the identifier of the logical channel associated with the secondary path corresponding to the SLRB to the second terminal device through a sidelink media access control control element (SL MAC CE), where the second terminal device is a terminal device in a group to which the first terminal device belongs, or the second terminal device is a terminal device that receives broadcast services.

In the present disclosure, the first terminal device can determine the identifier of the logical channel associated with the primary path and the identifier of the logical channel associated with the secondary path corresponding to the SLRB, where the logical channel associated with the primary path and the logical channel associated with the secondary path corresponding to the SLRB are mapped to different carriers or different carrier groups, and send the identifier of the logical channel associated with the primary path and the identifier of the logical channel associated with the secondary path corresponding to the SLRB to the second terminal device. Therefore, when PDCP duplication of the SLRB is activated, it can ensure that two data packets of PDCP duplication are transmitted using different logical channels.

It can be understood that the communication apparatus 1300 can be a network device, an apparatus in a network device, or an apparatus that can be used in conjunction with the network device.

The communication apparatus 1300 is on the network device side, where: the processing module 1301 is configured to determine an identifier of a logical channel associated with a primary path and an identifier of a logical channel associated with a secondary path corresponding to a sidelink radio bearer (SLRB), where the logical channel associated with the primary path and the logical channel associated with the secondary path corresponding to the SLRB are mapped to different carriers or different carrier groups; the transceiver module 1302 is configured to send configuration information to a first terminal device, where the configuration information includes the identifier of the logical channel associated with the primary path and the identifier of the logical channel associated with the secondary path corresponding to the SLRB.

Optionally, the processing module 1301 is configured to: select the identifier of the logical channel associated with the primary path corresponding to the SLRB from identifiers of existing logical channels, and selecting the identifier of the logical channel associated with the secondary path corresponding to the SLRB from identifiers of reserved logical channels, where identifiers of logical channels associated with primary paths corresponding to different SLRBs are different, and identifiers of logical channels associated with secondary paths corresponding to different SLRBs are different.

Optionally, the processing module 1301 is configured to: determine the identifier of the logical channel associated with the primary path and the identifier of the logical channel associated with the secondary path corresponding to the SLRB according to an hybrid automatic repeat request (HARQ) attribute of logical channels.

Optionally, the HARQ attribute of the logical channel associated with the primary path and the HARQ attribute of the logical channel associated with the secondary path are both HARQ enabled, or the HARQ attribute of the logical channel associated with the primary path and the HARQ attribute of the logical channel associated with the secondary path are both HARQ disabled.

Optionally, the HARQ attribute of the logical channel associated with the primary path is default; and the HARQ attribute of the logical channel associated with the secondary path is HARQ enabled or HARQ disabled, or the HARQ attribute of the logical channel associated with the secondary path is default.

In the present disclosure, the network device can determine the identifier of the logical channel associated with the primary path and the identifier of the logical channel associated with the secondary path corresponding to the SLRB, and send the configuration information to the first terminal device, where the configuration information includes the identifier of the logical channel associated with the primary path and the identifier of the logical channel associated with the secondary path corresponding to the SLRB. Thus, the first terminal device can determine the identifier of the logical channel associated with the primary path and the identifier of the logical channel associated with the secondary path corresponding to the SLRB according to the configuration information, thereby ensuring that two data packets of PDCP duplication are transmitted using different logical channels.

It can be understood that the communication apparatus 1300 can be a second terminal device, an apparatus in a second terminal device, or an apparatus that can be used in conjunction with the second terminal device.

The communication apparatus 1300 is on the second terminal device side, where: the transceiver module 1302 is configured to receive an identifier of a logical channel associated with a primary path and an identifier of a logical channel associated with a secondary path corresponding to a sidelink radio bearer (SLRB) sent by a first terminal device, where the logical channel associated with the primary path and the logical channel associated with the secondary path corresponding to the SLRB are mapped to different carriers or different carrier groups.

Optional, the transceiver module 1302 is configured to: receive the identifier of the logical channel associated with the primary path and the identifier of the logical channel associated with the secondary path corresponding to the SLRB sent by the first terminal device through PC5-radio resource control (PC5-RRC) signaling, where the second terminal device is a terminal device that establishes a PC5-RRC uncast connection with the first terminal device.

Optional, the transceiver module 1302 is configured to: receive the identifier of the logical channel associated with the primary path and the identifier of the logical channel associated with the secondary path corresponding to the SLRB sent by the first terminal device through a sidelink media access control control element (SL MAC CE), where the second terminal device is a terminal device that establishes a PC5-RRC uncast connection with the first terminal device.

Optional, the transceiver module 1302 is configured to: receive the identifier of the logical channel associated with the primary path and the identifier of the logical channel associated with the secondary path corresponding to the SLRB sent by the first terminal device through a sidelink media access control control element (SL MAC CE), where the second terminal device is a terminal device in a group to which the first terminal device belongs, or the second terminal device is a terminal device that receives broadcast services.

Referring to FIG. 14, FIG. 14 is a schematic structural diagram of another communication apparatus provided in an embodiment of the present disclosure. In FIG. 14, the communication apparatus 1400 may be a network device, or a terminal device, or a chip, a chip system, a processor or the like that supports the network device to implement the above methods, or may be a chip, a chip system, a processor or the like that supports the terminal device to implement the above methods. The apparatus may be used to implement the methods described in the above method embodiments, and for details, the descriptions in the above method embodiments may be referred to.

The communication apparatus 1400 may include one or more processors 1401. The processor 1401 may be a general-purpose processor or a special-purpose processor. For example, the processor 1401 may be a baseband processor or a central processing unit. The baseband processor may be used to process the communication protocol and communication data, and the central processing unit may be used to control the communication apparatus (for example, a base station, a baseband chip, a terminal device, a terminal device chip, a DU or a CU, etc.), execute a computer program and process data of the computer program.

Optionally, the communication apparatus 1400 may further include one or more memories 1402, on which a computer program 1404 may be stored. The processor 1401 executes the computer program 1404, so that the communication apparatus 1400 executes the methods described in the above method embodiments. Optionally, data may also be stored in the memory 1402. The communication apparatus 1400 and the memory 1402 may be set separately or integrated together.

Optionally, the communication apparatus 1400 may further include a transceiver 1405 and an antenna 1406. The transceiver 1405 may be called a transceiver unit, a transceiver machine, or a transceiver circuit, etc., and is used to implement a transceiver function. The transceiver 1405 may include a receiver and a transmitter. The receiver may be called a receiving machine or a receiving circuit for realizing a receiving function. The transmitter may be called a transmitting machine or a sending circuit for realizing a sending function.

Optionally, the communication apparatus 1400 may also include one or interface circuits 1407. The interface circuit 1407 is used to receive code instructions and transmit them to the processor 1401. The processor 1401 executes the code instructions to enable the communication apparatus 1400 to execute the methods described in the foregoing method embodiments.

The communication apparatus 1400 is the first terminal device: the processor 1401 is used to execute step 201 in FIG. 2; step 301 in FIG. 3; step 401 in FIG. 4; step 502 in FIG. 5; step 602 in FIG. 6, etc. The communication apparatus 1400 is a network device: the transceiver 1405 is used to perform step 702 in FIG. 7; step 802 in FIG. 8; step 902 in FIG. 9.

In an implementation, the processor 1401 can include a transceiver for implementing receiving and sending functions. For example, the transceiver may be a transceiver circuit, or an interface, or an interface circuit. The transceiver circuit, the interface or the interface circuit for realizing receiving and sending functions may be separated or integrated together. The above-mentioned transceiver circuit, interface or interface circuit may be used for reading and writing code/data, or the above-mentioned transceiver circuit, interface or interface circuit may be used for signal transmission or transfer.

In an implementation, the processor 1401 may store the computer program 1403 which, when runs on the processor 1401, causes the communication apparatus 1400 to perform the methods described in the above method embodiments. The computer program 1403 may be fixed in the processor 1401, in which case the processor 1401 may be implemented by hardware.

In an implementation, the communication apparatus 1400 may include a circuit, and the circuit may implement the function of sending or receiving or communicating in the foregoing method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be fabricated using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), a silicon germanium (SiGe), a gallium arsenide (GaAs), etc.

The communication apparatus described in the above embodiments may be a network device or a terminal device, but the scope of the communication apparatus described in the present disclosure is not limited thereto, and the structure of the communication apparatus may not be limited by that shown in FIG. 14. The communication apparatus may be a stand-alone device or may be part of a relatively large device. For example, the communication apparatus may be:
(1) a stand-alone integrated circuit (IC), or a chip, or a chip system or a subsystem;
(2) a set with one or more ICs, optionally, the set of ICs may also include a storage component for storing data and the computer program;
(3) ASIC, such as a Modem;
(4) a module that can be embedded in another device;
(5) a receiver, a terminal device, an intelligent terminal device, a cellular phone, a wireless device, a handset, a mobile unit, a vehicle-mounted device, a network device, a cloud device, an artificial intelligence device, etc. ;
(6) others and so on.

For the case where the communication apparatus may be a chip or a chip system, the schematic structural diagram of the chip shown in FIG. 15 may be referred to. The chip 1500 shown in FIG. 15 includes a processor 1501 and an interface 1503. The number of processors 1501 may be one or more, and the number of interfaces 1503 may be more than one.

For the case where the chip is used to realize the function of the first terminal device in the embodiments of the present disclosure: interface 1503, used to execute step 202 in FIG. 2; step 302 in FIG. 3; step 402 in FIG. 4; steps 501 and 503 in FIG. 5; steps 601 and 603 in FIG. 6, etc. interface 1503, used to execute step 1001 in FIG. 10; step 1101 in FIG. 11; step 1201 in FIG. 12, etc.

For the case where the chip is used to implement the function of the network device in the embodiments of the present disclosure: interface 1503, used to execute step 702 in FIG. 7; step 802 in FIG. 8; step 902 in FIG. 9.

Optionally, the chip also includes a memory 1502, which is used to store necessary computer programs and data.

Those skilled in the art can also understand that various illustrative logical blocks and steps listed in the embodiments of the present disclosure can be implemented by an electronic hardware, computer software, or a combination of both. Whether such functions are implemented by hardware or software depends on the specific application and the design requirements of the overall system. Those skilled in the art may use various methods to implement the described functions for each specific application, but such implementation should not be understood as going beyond the protection scope of the embodiments of the present disclosure.

The present disclosure also provides a readable storage medium on which instructions are stored, and when the instructions are executed by a computer, the functions of any one of the above method embodiments are realized.

The present disclosure also provides a computer program product which, when executed by a computer, implements the functions of any one of the above method embodiments.

In the above embodiments, all or part of them may be implemented by software, hardware, firmware or any combination thereof. When implemented using software, it may be implemented in whole or in part in the form of a computer program product. The computer program product includes one or more computer programs. When the computer program is loaded and executed on a computer, all or part of the processes or functions according to the embodiments of the present disclosure are generated. The computer can be a general-purpose computer, a special-purpose computer, a computer network, or other programmable apparatuses. The computer program can be stored in the computer readable storage medium or transmitted from one computer readable storage medium to another computer readable storage medium, for example, the computer program can be transmitted from one website site, computer, server or data center to another website site, computer, server or data center by wired (for example, a coaxial cable, an optical fiber, a digital subscriber line (DSL)) or wireless (for example, infrared, wireless, microwave, etc.) manner. The computer readable storage medium may be any available medium that can be accessed by a computer, or a data storage device such as a server or a data center integrated with one or more available media. The available medium may be a magnetic medium (for example, a floppy disk, a hard disk, a magnetic tape), an optical medium (for example, a digital video disc (DVD)), or a semiconductor medium (for example, a solid state disk (SSD)), etc.

Those of ordinary skill in the art can understand that the first, second, and other numbers involved in the present disclosure are only for convenience of description, and are not used to limit the scope of the embodiments of the present disclosure, and also indicate the sequence.

At least one in the present disclosure can also be described as one or more, and a plurality of can be two, three, four or more, which is not limited in the present disclosure. In the embodiments of the present disclosure, for a technical feature, the technical features are distinguished by “first”, “second”, “third”, “A”, “B”, “C” and “D”, etc. The technical features described by the “first”, “second”, “third”, “A”, “B”, “C” and “D” have no sequence or order of magnitude therebetween.

The corresponding relationships shown in the tables in the present disclosure can be configured or predefined. The values of the information in each table are just examples, and may be configured as other values, which are not limited in the present disclosure. When configuring the corresponding relationship between the information and each parameter, it is not necessarily required to configure all the corresponding relationships shown in the tables. For example, in the table in the present disclosure, the corresponding relationship shown in some rows may not be configured. For another example, appropriate deformation adjustments can be made based on the above tables, for example, splitting, merging, and so on. The names of parameters shown in titles in the above tables may also adopt other names understandable by the communication apparatus, and the values or representations of the parameters may also be other values or representations understandable by the communication apparatus. When the above tables are implemented, other data structures can also be used, for example, arrays, queues, containers, stacks, linear tables, pointers, linked lists, trees, graphs, structures, classes, heaps, hashtables or hash tables.

1. A method for determining an identifier of a sidelink logical channel, performed by a first terminal device, the method comprising:
determining an identifier of a logical channel associated with a primary path and an identifier of a logical channel associated with a secondary path corresponding to a sidelink radio bearer (SLRB), wherein the logical channel associated with the primary path and the logical channel associated with the secondary path corresponding to the SLRB are mapped to different carriers or different carrier groups; and
sending the identifier of the logical channel associated with the primary path and the identifier of the logical channel associated with the secondary path corresponding to the SLRB to a second terminal device.

2. The method according to claim 1, wherein determining the identifier of the logical channel associated with the primary path and the identifier of the logical channel associated with the secondary path corresponding to the SLRB comprises:
selecting the identifier of the logical channel associated with the primary path corresponding to the SLRB from identifiers of existing logical channels, and selecting the identifier of the logical channel associated with the secondary path corresponding to the SLRB from identifiers of reserved logical channels, wherein identifiers of logical channels associated with primary paths corresponding to different SLRBs are different, and identifiers of logical channels associated with secondary paths corresponding to different SLRBs are different.

3. The method according to claim 1, wherein determining the identifier of the logical channel associated with the primary path and the identifier of the logical channel associated with the secondary path corresponding to the SLRB comprises:
determining the identifier of the logical channel associated with the primary path and the identifier of the logical channel associated with the secondary path corresponding to the SLRB according to an hybrid automatic repeat request (HARQ) attribute of logical channels.

4. The method according to claim 3, wherein the HARQ attribute of the logical channel associated with the primary path and the HARQ attribute of the logical channel associated with the secondary path are both HARQ enabled, or the HARQ attribute of the logical channel associated with the primary path and the HARQ attribute of the logical channel associated with the secondary path are both HARQ disabled.

5. The method according to claim 3, wherein the HARQ attribute of the logical channel associated with the primary path is default; and the HARQ attribute of the logical channel associated with the secondary path is HARQ enabled or HARQ disabled, or the HARQ attribute of the logical channel associated with the secondary path is default.

6. The method according to claim 1, wherein determining the identifier of the logical channel associated with the primary path and the identifier of the logical channel associated with the secondary path corresponding to the SLRB comprises:
receiving configuration information sent by a network device; and
determining the identifier of the logical channel associated with the primary path and the identifier of the logical channel associated with the secondary path corresponding to the SLRB according to the configuration information.

7. (canceled)

8. The method according to claim 1, wherein sending the identifier of the logical channel associated with the primary path and the identifier of the logical channel associated with the secondary path corresponding to the SLRB to the second terminal device comprises:
sending the identifier of the logical channel associated with the primary path and the identifier of the logical channel associated with the secondary path corresponding to the SLRB to the second terminal device through PC5-radio resource control (PC5-RRC) signaling, wherein the second terminal device is a terminal device that establishes a PC5-RRC uncast connection with the first terminal device.

9. The method according to claim 1, wherein sending the identifier of the logical channel associated with the primary path and the identifier of the logical channel associated with the secondary path corresponding to the SLRB to the second terminal device comprises:
sending the identifier of the logical channel associated with the primary path and the identifier of the logical channel associated with the secondary path corresponding to the SLRB to the second terminal device through a sidelink media access control control element (SL MAC CE), wherein the second terminal device is a terminal device that establishes a PC5-RRC uncast connection with the first terminal device.

10. The method according to claim 1, wherein sending the identifier of the logical channel associated with the primary path and the identifier of the logical channel associated with the secondary path corresponding to the SLRB to the second terminal device comprises:
sending the identifier of the logical channel associated with the primary path and the identifier of the logical channel associated with the secondary path corresponding to the SLRB to the second terminal device through a sidelink media access control control element (SL MAC CE), wherein the second terminal device is a terminal device in a group to which the first terminal device belongs, or the second terminal device is a terminal device that receives broadcast services.

11. A method for determining an identifier of a sidelink logical channel, performed by a network device, the method comprising:
determining an identifier of a logical channel associated with a primary path and an identifier of a logical channel associated with a secondary path corresponding to a sidelink radio bearer (SLRB), wherein the logical channel associated with the primary path and the logical channel associated with the secondary path corresponding to the SLRB are mapped to different carriers or different carrier groups; and
sending configuration information to a first terminal device, wherein the configuration information comprises the identifier of the logical channel associated with the primary path and the identifier of the logical channel associated with the secondary path corresponding to the SLRB.

12. The method according to claim 11, wherein determining the identifier of the logical channel associated with the primary path and the identifier of the logical channel associated with the secondary path corresponding to the SLRB comprises:
selecting the identifier of the logical channel associated with the primary path corresponding to the SLRB from identifiers of existing logical channels, and selecting the identifier of the logical channel associated with the secondary path corresponding to the SLRB from identifiers of reserved logical channels, wherein identifiers of logical channels associated with primary paths corresponding to different SLRBs are different, and identifiers of logical channels associated with secondary paths corresponding to different SLRBs are different.

13. The method according to claim 11, wherein determining the identifier of the logical channel associated with the primary path and the identifier of the logical channel associated with the secondary path corresponding to the SLRB comprises:
determining the identifier of the logical channel associated with the primary path and the identifier of the logical channel associated with the secondary path corresponding to the SLRB according to an hybrid automatic repeat request (HARQ) attribute of logical channels.

14. (canceled)

15. (canceled)

16. A method for determining an identifier of a sidelink logical channel, performed by a second terminal device, the method comprising:
receiving an identifier of a logical channel associated with a primary path and an identifier of a logical channel associated with a secondary path corresponding to a sidelink radio bearer (SLRB) sent by a first terminal device, wherein the logical channel associated with the primary path and the logical channel associated with the secondary path corresponding to the SLRB are mapped to different carriers or different carrier groups.

17. The method according to claim 16, wherein receiving the identifier of the logical channel associated with the primary path and the identifier of the logical channel associated with the secondary path corresponding to the SLRB sent by the first terminal device comprises at least one of:
receiving the identifier of the logical channel associated with the primary path and the identifier of the logical channel associated with the secondary path corresponding to the SLRB sent by the first terminal device through PC5-radio resource control (PC5-RRC) signaling, wherein the second terminal device is a terminal device that establishes a PC5-RRC uncast connection with the first terminal device;
receiving the identifier of the logical channel associated with the primary path and the identifier of the logical channel associated with the secondary path corresponding to the SLRB sent by the first terminal device through a sidelink media access control control element (SL MAC CE), wherein the second terminal device is a terminal device that establishes a PC5-RRC uncast connection with the first terminal device; or
receiving the identifier of the logical channel associated with the primary path and the identifier of the logical channel associated with the secondary path corresponding to the SLRB sent by the first terminal device through a sidelink media access control control element (SL MAC CE), wherein the second terminal device is a terminal device in a group to which the first terminal device belongs, or the second terminal device is a terminal device that receives broadcast services.

18.-22. (canceled)

23. A communication apparatus, comprising one or more processors and a memory, wherein the memory stores a computer program, and the one or more processors execute the computer program stored in the memory to cause the communication apparatus to perform the method according to claim 1.

24. (canceled)

25. A communication apparatus, comprising one or more processors and a memory, wherein the memory stores a computer program, and the one or more processors execute the computer program stored in the memory to cause the communication apparatus to perform the method according to claim 11.

26. A communication apparatus, comprising one or more processors and a memory, wherein the memory stores a computer program, and the one or more processors execute the computer program stored in the memory to cause the communication apparatus to perform the method according to claim 16.

27. A non-transitory computer readable storage medium storing instructions that, when executed by a processor, cause the processor to perform the method according to claim 1.

28. A non-transitory computer readable storage medium storing instructions that, when executed by a processor, cause the processor to perform the method according to claim 11.

29. A non-transitory computer readable storage medium storing instructions that, when executed by a processor, cause the processor to perform the method according to claim 16.
